(19) United States
(12) Patent Application Publication
(10) Pub. No.: US 2024/0086847 A1
(43) Pub. Date: Mar. 14, 2024

(54) Inventor Directory System and Method

(71) Applicant: Consumeron LLC, Los Angeles, CA (US)

(72) Inventor: Mark B. Barron, Bel Air, CA (US)

(73) Assignee: Consumeron LLC, Los Angeles, CA (US)

(21) Appl. No.: 18/367,170

(22) Filed: Sep. 12, 2023

Related U.S. Application Data
(60) Provisional application No. 63/406,041, filed on Sep. 13, 2022.

(51) Int. Cl. G06Q 10/10; G06Q 10/0631

(52) U.S. Cl. CPC G06Q 10/103; G06Q 10/063112

(57) ABSTRACT

An inventor directory system is configured to store information about one or more inventors having one or more prior patents in their name, information about one or more clients and information about one or more projects. Each project represents a problem to which one or more solutions is desired by a particular client, while an inventor is an entity who is qualified and willing to help solve a problem. Each inventor is vetted, such that a particular level of expertise in one or more given fields is attributed to the inventor. The system links, such as through a computer app, a given client with one or more of the vetted inventors based on the expertise of the inventor(s) and the problem of the client. The system provides for establishing a communication link between the client and the inventor(s) in discussing the project and/or conducting a transaction between the parties.

### CROSS-REFERENCE TO RELATED APPLICATIONS

This application claims priority to U.S. Provisional Patent Application No. 63/406,041 filed Sep. 13, 2022, entitled “Inventor Directory System and Method”, which is incorporated herein by reference.

### BACKGROUND OF THE INVENTION

Entities ranging from individuals to communities, and even to the world at large, face challenges and problems that can be complex in nature. For example, on a macro level, climate change, crime, wildfires and droughts are current and high-level problems that are not easily solved. In many instances, experts are consulted as part of the problem-solving process.

### SUMMARY OF THE INVENTION

The present invention recognizes that inventors in particular can be an invaluable resource in problem-solving. Inventors are problem solvers by nature and are involved in many different categories of innovation. Many inventors obtain one or more patents to legally protect their inventions and patents can signify inventors as being qualified in their field. The present invention facilitates problem-solving by connecting inventors, preferably qualified inventors, with clients (e.g., a government agency, a non-profit organization, etc.) seeking solutions to particular problems.

The present invention is directed to an inventor directory system and methods related thereto. An inventor directory system in accordance with the present invention includes computing devices for a client and an inventor. The client is an entity seeking one or more solutions to a problem, while an inventor is an entity willing to help solve a problem. Preferably, the inventor is a qualified inventor (defined further below). The system further includes a network that provides communication between the computing devices and a host server that stores a website or application and a database. The website or application facilitates the creation of and access to information stored on the database and includes information about one or more inventors (e.g., categories of expertise/experience), information about one or more clients, and information about one or more projects (e.g., project code/identification number; compensation details). Ideally, a project concerns one or more problems regarding a particular topic or category of interest for which the client is seeking one or more solutions. A project can concern complex, high-level problems including, but not limited to, climate change, crime, wildfires and droughts.

The website or application is configured upon request from a user to access and display information stored on the database. The request may be a request to display select profiles (e.g., only profiles indicating a certain category) or may be a request to display all profiles. Preferably, the requested information is displayed in the form of a list of profiles and the website or application allows the user to sort and/or filter the list of profiles by one or more attributes (e.g., category of expertise).

In some embodiments, the website or application is configured to facilitate communication or a transaction (e.g., payment) between users of the system. In some embodiments, access to the system is exclusive and an individual inventor is vetted before having their respective inventor profile created as part of the inventor directory.

A method of creating an inventor directory system in accordance with the present invention includes storing information about an inventor, information about a client and information about a project. Storing the information can include storing the information in a database located on a host server that also includes a website or application. In some embodiments, the method of creating an inventor directory system further includes creating the information about an inventor, the information about a client and/or the information about a project.

A method of using an inventor directory system in accordance with the present invention includes accessing information about an inventor, information about a client and/or information about a project. Preferably, accessing the information includes accessing a database located on a host server that also includes a website or application. Accessing the information can include communicating with the host server via a network using one or more computing devices.

In some embodiments, the method of using an inventor directory system further includes displaying the accessed information. Preferably, displaying the accessed information includes displaying the accessed information using a user interface of a computing device.

The method of using an inventor directory system in accordance with the present invention can include sending a communication to a user of the system and/or conducting a transaction between users of the system (e.g., between an inventor and a client).

In a preferred embodiment, the method of using an inventor directory system includes vetting a candidate inventor for inclusion in the inventor directory. Vetting a candidate inventor includes establishing a particular level of expertise in one or more given fields attributed to the inventor and can include nominating a candidate inventor to a committee for approval.

Additional objects, features and advantages of the present invention will become more readily apparent from the following detailed description of the invention.

### BRIEF DESCRIPTION OF THE DRAWINGS

FIG. 1 is a schematic diagram of an inventor directory system according to the present invention.

### DETAILED DESCRIPTION OF THE INVENTION

For purposes of this description, some reference will be made to the drawings in describing numerous preferred features which can be employed in part, or in any combination, in establishing an inventor directory system. Certainly, it should be understood that aspects of the invention could be realized in various forms.

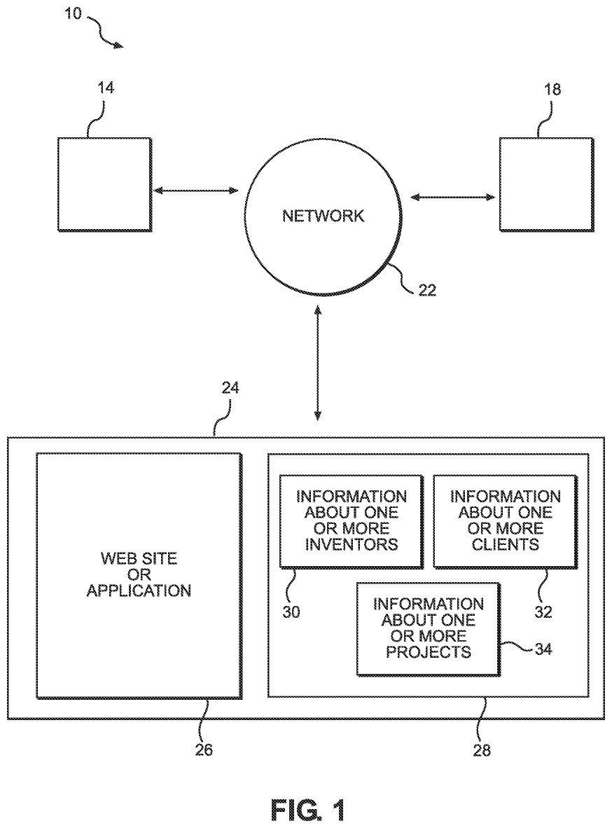

With reference to FIG. 1, an inventor directory system in accordance with the present invention is indicated at 10. System 10 includes computing devices 14 and 18 for a client and an inventor, respectively (collectively, users). The client is an entity seeking one or more solutions to a particular problem, while an inventor is an entity willing to help solve the problem. Clients can include, but are not limited to, a local, state or federal government agency, a non-profit organization or a for-profit organization, and can concern one or more of a variety of disciplines, e.g., forestry, law enforcement, environment, international relations, etc. Preferably, the inventor is a qualified inventor which, at least in part, is defined as an individual listed as an inventor, joint inventor or co-inventor on one or more filed patent application documents. The one or more patent application documents may be filed with any national, regional or international patent office including, but limited to, the United States Patent and Trademark Office (USPTO) and the European Patent Office (EPO), and can include Patent Cooperation Treaty (PCT) application documents.

Computing devices 14 and 18 are electronic devices each configured with a user interface (not shown in FIG. 1) to interact with the users. Examples of computing devices 14 and 18 include, but are not limited to, a personal computer (PC), a mobile phone, a tablet device, a personal digital assistant (PDA), a smart phone, a computer kiosk and a laptop. Examples of the user interface include, but are not limited to, a display screen, a keyboard, a mouse, and/or a stylus.

System 10 further includes a network 22 (e.g., the internet) that provides communication between computing devices 14 and 18 and a host server 24 that stores a website or application 26 and a database 28. In a preferred embodiment, website or application 26 and/or database 28 is/are encrypted. Website or application 26 facilitates the creation of and access to information stored on database 28. Such information is created by user input via their respective computing device and is accessed by a user via their respective computing device. The information created includes information 30 about one or more inventors, information 32 about one or more clients, and information 34 about one or more projects. The costs associated with running host server 24 can be funded, e.g., by government entities and/or international organizations.

Information 30 about an inventor (i.e., the inventor directory) includes an inventor profile which can feature biographical information (e.g., name(s), occupation(s), age, etc.), contact information (e.g., email address, phone number, etc.), the inventor's prior patents or patent applications, the inventor's one or more categories of expertise/experience (e.g., environment, etc.), as well as any current or prior projects the inventor is working or has worked on as part of their association with the inventor directory. Typically, the current or prior project the inventor is working or has worked on as part of their association with the inventor directory is identified using a project code or number and includes a status indicator (e.g., new, accepting inventors, pending, finished, etc.). The inventor profile can also include a personal summary statement created by the inventor and ideally highlighting the inventor's skills, strengths and experience. In a preferred embodiment, the inventor profile includes an explicit indication of whether the inventor is a qualified inventor (i.e., an individual listed as an inventor, joint inventor or co-inventor on one or more filed patent application documents, as described above).

Information 32 about a client includes a client profile which can feature basic information (e.g., name(s), location, etc.), contact information (e.g., email address, phone number, etc.), the client's one or more categories of interest (e.g., environment, etc.), as well as any current or prior projects the client is/was involved with as part of their association with the inventor directory. Typically, the current or prior project the client is/was involved with as part of their association with the inventor directory is identified using a project code or number and includes a status indicator (e.g., new, accepting inventors, pending, finished, etc.). The client profile can also include a summary statement created by the client and ideally highlighting the client's interests and objectives. An individual user can have either or both an inventor profile and a client profile (i.e., an inventor can also be a client seeking help from other inventors).

Information 34 about a project includes a project profile for a project commissioned by one or more clients and worked/being worked on by one or more inventors. Ideally, the project concerns one or more problems regarding a particular topic or category of interest for which the client is seeking one or more solutions. A project can concern complex, high-level problems including, but not limited to, climate change, crime, wildfires and droughts. In a preferred embodiment, the project profile includes a project title, client information and a summary of objectives and/or problems to be solved. The project profile can also feature a project code/identification number, project status (e.g., new, accepting inventors, pending, finished, etc.), project category (e.g., environment, etc.), names of all inventors involved with the project (preferably, each inventor has a profile as part of information 30 stored on database 28), project compensation details and/or project contribution details. Project compensation details indicate the offered/proposed, pending, or actual/final compensation for one or more inventors associated with the project. A project may offer no compensation, may offer hourly, weekly, monthly, etc. compensation or may offer compensation contingent upon one or more success metrics (e.g., completed milestones). Project contribution details indicate the degree of contribution anticipated or achieved by one or more inventors associated with the project.

Website or application 26 is configured upon request from a user to access and display information 30 about one or more inventors stored on database 28. The request may be a request to display select inventor profiles (e.g., only inventor profiles indicating a certain category and/or prior experience with a project associated with the inventory directory). The request may be a request to display all inventor profiles. Preferably, requested information 30 is displayed in the form of a list of inventor profiles, and website or application 26 allows the user to sort and/or filter the list of inventor profiles by one or more attributes (e.g., category of expertise).

Website or application 26 is also configured upon request from a user to access and display information 32 about one or more clients stored on database 28. The request may be a request to display select client profiles (e.g., only client profiles indicating a certain category). The request may be a request to display all client profiles. Preferably, requested information 32 is displayed in the form of a list of client profiles, and website or application 26 allows the user to sort and/or filter the list of client profiles by one or more attributes (e.g., category of interest).

Additionally, website or application 26 is configured upon request from a user to access and display information 34 about one or more projects stored on database 28. The request may be a request to display select project profiles (e.g., only project profiles that are new or currently accepting inventors). The request may be a request to display all project profiles. Preferably, requested information 34 is displayed in the form of a list of project profiles, and website or application 26 allows the user to sort and/or filter the list of project profiles by one or more attributes (e.g., amount of compensation offered).

In some embodiments, website or application 26 is configured to facilitate communication or a transaction (e.g., payment) between users of system 10. For example, website or application 26 is configured to facilitate communications regarding and/or establishing a contract detailing compensation and/or expectations on the part of a client and/or inventor for a project. One or more inventors and one or more clients can be associated with a single project. Also, a singular inventor or client can be involved in more than one project at a time.

In some embodiments, access to system 10 (website or application 26 and database 28, in particular) is exclusive (e.g., by invitation only). In a preferred embodiment, an individual inventor is vetted before having their respective inventor profile created as part of the inventor directory. For example, website or application 26 can be configured to facilitate the nomination of a candidate inventor to a committee for approval (e.g., the committee holds a vote to approve the candidate inventor's inclusion in the inventor directory). An inventor with an existing inventor profile in the inventor directory can nominate, using website or application 26, a candidate inventor. Approval of a successful candidate inventor requires the candidate being credited to be an inventor, joint inventor or co-inventor on one or more filed patent application documents.

A method of creating an inventor directory system in accordance with the present invention includes storing information about an inventor, information about a client and information about a project. Storing the information can include storing the information in a database located on a host server that also includes a website or application.

In some embodiments, the method of creating an inventor directory system further includes creating the information about an inventor, the information about a client and/or the information about a project. Preferably, the information about an inventor, the information about a client and/or the information about a project is created using one or more computing devices. Creating information about an inventor can include creating an inventor profile. As described above, an inventor profile can feature a personal summary, biographical information (e.g., name(s), occupation(s), age, etc.), contact information (e.g., email address, phone number, etc.), the inventor's prior patents or patent applications, the inventor's one or more categories of expertise/experience (e.g., environment, etc.), any current or prior projects the inventor is working/worked on as part of their association with the inventor directory and/or an indication of whether the inventor is a qualified inventor. Creating information about a client can include creating a client profile. As described above, a client profile can feature a summary statement, basic information (e.g., name(s), location, etc.), contact information (e.g., email address, phone number, etc.), the client's one or more categories of interest (e.g., environment, etc.), as well as any current or prior projects the client is/was involved with as part of their association with the inventor directory. Creating information about a project can include creating a project profile. As described above, a project profile can feature a project title, client information, a summary of objectives and/or problems to be solved, project code/identification number, project status (e.g., new, accepting inventors, pending, finished, etc.), project category (e.g., environment, etc.), names of all inventors involved with the project, project compensation details and/or project contribution details.

A method of using an inventor directory system in accordance with the present invention includes accessing information about an inventor, information about a client and/or information about a project. Preferably, accessing the information includes accessing a database located on a host server that also includes a website or application. Accessing the information can include communicating with the host server via a network using one or more computing devices.

In some embodiments, the method of using an inventor directory system further includes displaying the accessed information. Preferably, displaying the accessed information includes displaying the accessed information using a user interface of a computing device.

Displaying information about an inventor may include displaying select or targeted inventor profiles (e.g., only inventor profiles indicating a certain category and/or prior experience with a project associated with the inventory directory). Displaying information about an inventor may include displaying all inventor profiles. Preferably, displaying information about an inventor includes displaying the information in the form of a list of inventor profiles. In some embodiments, the method further includes sorting and/or filtering the list of inventor profiles by one or more attributes (e.g., category of expertise).

Displaying information about a client may include displaying select client profiles (e.g., only client profiles indicating a certain category). Displaying information about a client may include displaying all client profiles. Preferably, displaying information about a client includes displaying the information in the form of a list of client profiles. In some embodiments, the method further includes sorting and/or filtering the list of client profiles by one or more attributes (e.g., category of expertise).

Displaying information about a project may include displaying select project profiles (e.g., only project profiles that are new or currently accepting inventors). Displaying information about a project may include displaying all inventor profiles. Preferably, displaying information about a project includes displaying the information in the form of a list of project profiles. In some embodiments, the method further includes sorting and/or filtering the list of project profiles by one or more attributes (e.g., amount of compensation offered).

The method of using an inventor directory system in accordance with the present invention can include sending a communication to a user of the system and/or conducting a transaction between users of the system (e.g., between an inventor and a client). For example, sending a communication can include sending a contract and conducting a transaction between users can include paying a user of the system.

In a preferred embodiment, the method of using an inventor directory system includes vetting a candidate inventor for inclusion in the inventor directory. Vetting a candidate inventor for establishing a particular level of expertise in one or more given fields attributed to the inventor, with the vetting potentially including nominating a candidate inventor to a committee for approval. An inventor with an existing inventor profile in the inventor directory can nominate a candidate inventor. Approval of a successful candidate inventor may require, e.g., the candidate being credited as an inventor, joint inventor or co-inventor on one or more filed patent application documents.

Periodically (e.g., annually), successes achieved using the inventor directory system and methods of the present invention can be recognized at a ceremony (e.g., inventors/clients are given an award). For example, for unique or overwhelming successful solutions to challenges facing mankind, inventors/clients can be recognized during the Academy Awards or other dignitary events or even at world summit meetings (e.g., the World Economic Forum Annual Meeting in Davos, Switzerland; the annual G7 summit; etc.).

Although described with reference to preferred embodiments of the invention, it should be understood that various changes and/or modification can be made without departing from the invention.

What is claimed is:

1. A directory system for problem solving comprising:
a first database containing information on inventors, each inventor constituting a vetted individual determined to have a particular level of expertise in one or more fields;
a second database containing information on at least one client;
a project established by the at least one client, with the project relating to a problem to which one or more solutions is desired by the at least one client; and
a link configured to establish communication between the at least one client and one or more of the inventors regarding solving the problem.

2. The directory system of claim 1, wherein each inventor must have one or more pending patent applications or issued patents under their name in order to be considered to have the particular level of expertise in the one or more fields.

3. The directory system of claim 2, wherein the one or more patent applications must have been filed with any national, regional or international patent office.

4. The directory system of claim 1, wherein the link includes a computer app used by both the at least one client and the one or more inventors.

5. The directory system of claim 4, wherein the computer app is on at least one of a network server, a personal computer (PC), a mobile phone, a tablet device, a personal digital assistant (PDA), a smart phone, a computer kiosk or a laptop.

6. The directory system of claim 5, wherein the system includes a network server storing the first and second databases, and a host server configured to enable the communication between the at least one client and the one or more inventors.

7. The directory system of claim 1, wherein the at least one client is a local, state or federal government agency, a non-profit organization or a for-profit organization.

8. The directory system of claim 1, wherein the information on the first database includes an inventor profile having a personal summary statement, created by a respective one of the inventors, highlighting information related to the inventor's expertise.

9. The directory system of claim 8, wherein the information on the second database includes a client profile having a summary statement, created by a respective client, highlighting the client's interests and objectives in relation to the project.

10. The directory system of claim 1, wherein the link is configured to establish communication between the at least one client and the one or more of the inventors regarding establishing a contract detailing compensation and/or expectations on the part of the at least one client and/or the one or more of the inventors for the project.

11. A method of solving a problem using an inventor directory system comprising:
establishing a project profile on the inventor directory system based on information from a client, with the project profile including information relating to a problem to which one or more solutions is desired by the client;
providing access to the information on the problem by one or more inventors stored from an inventor database of the inventor directory system, with each inventor constituting a vetted individual determined to have a particular level of expertise in one or more fields related to the problem; and
using a link, established through the inventor directory system, to establish communication between the client and the one or more inventors regarding solving the problem.

12. The method of claim 11, wherein each inventor is vetted to assure the inventor has one or more pending patent applications or issued patents in their name.

13. The method of claim 12, wherein the one or more patent applications must have been filed with any national, regional or international patent office.

14. The method of claim 12, further comprising receiving a nomination, through the inventor directory system, in vetting the individual.

15. The method of claim 11, wherein the link is established using a computer app by both the client and the one or more inventors.

16. The method of claim 15, wherein the computer app is on at least one of a network server, a personal computer (PC), a mobile phone, a tablet device, a personal digital assistant (PDA), a smart phone, a computer kiosk or a laptop.

17. The method of claim 15, further comprising using the link to establish a contract detailing compensation and/or expectations on the part of the client and/or the one or more of the inventors for the project profile.

18. The method of claim 11, wherein the client is a local, state or federal government agency, a non-profit organization or a for-profit organization.

19. The method of claim 11, further comprising establishing an inventor profile on the inventor directory system for each of the one or more inventors, with the inventor profile including a personal summary statement, created by a respective one of the inventors, highlighting the inventor's skills, strengths and experience.

20. The method of claim 11, wherein establishing a project profile includes a summary statement, created by a respective client, highlighting the client's interests and objectives in relation to the project.
